(19) United States
(12) Patent Application Publication
(10) Pub. No.: US 2013/0262762 A1
(43) Pub. Date: Oct. 3, 2013

(54) STORAGE SYSTEM AND STORAGE CONTROL METHOD

(71) Applicant: FUJITSU LIMITED, Kawasaki-shi (JP)

(72) Inventors: Atsushi Igashira, Yokohama (JP); Norihide Kubota, Kawasaki (JP); Kenji Kobayashi, Kawasaki (JP); Ryota Tsukahara, Kawasaki (JP); Hidejirou Daikokuya, Kawasaki (JP); Kazuhiko Ikeuchi, Kawasaki (JP); Chikashi Maeda, Kawasaki (JP); Takeshi Watanabe, Kawasaki (JP)

(73) Assignee: FUJITSU LIMITED, Kawasaki-shi (JP)

(21) Appl. No.: 13/845,238

(22) Filed: Mar. 18, 2013

(30) Foreign Application Priority Data
Mar. 30, 2012 (JP) 2012-080651

(51) Int. Cl. G06F 12/00

(52) U.S. Cl. CPC G06F 12/00
USPC 711/114; 711/154

(57) ABSTRACT

A storage system includes a storage device having a command reordering function and a storage control apparatus that controls access to the storage device. Commands are issued to the storage device for reading or writing data. The storage control apparatus sets an upper limit to write data size or read data size specified in the commands during a predetermined period after a timeout of an issued command, so as to make it less likely for the storage device to postpone some of the issued commands.

### CROSS-REFERENCE TO RELATED APPLICATION

This application is based upon and claims the benefit of priority of the prior Japanese Patent Application No. 2012-080651, filed on Mar. 30, 2012, the entire contents of which are incorporated herein by reference.

### FIELD

The embodiments discussed herein relate to a storage system and a storage control method.

### BACKGROUND

In a data storage system, mass-storage devices such as hard disk drives (HDD) execute an increasingly large number of data access commands. This tendency has become more prominent as a result of advancement of high-capacity HDDs and growing demands for larger storage systems. The command queues in HDDs could be occupied by an excessive amount of pending commands, which leads to slowdown of read and write operations on those HDDs.

To alleviate the above problem, some of the recent HDDs have a function of changing the order of execution of commands stored in their command queues so as to reduce the processing time of those commands as a whole. With this command reordering function, the HDD firmware optimizes the execution order of pending commands in the queue toward shorter head seek time and reduced rotational latency.

As another technique for reducing the processing time of HDD access, there is proposed a storage system that stores data and its parity in different HDDs. When an HDD storing data is in suspend state, the storage system does not reactivate that HDD to read its stored data, but uses instead the parity read out of another HDD that is active. See, for example, the following documents.
Japanese Laid-open Patent Publication No. 2002-23962
Japanese Laid-open Patent Publication No. 2009-163310

With the above-noted reordering function, the HDDs execute some commands in preference to other commands, which could cause a large delay in execution of the latter group of commands. The sender of these commands may detect a timeout of commands when their delay is excessive.

### SUMMARY

According to an aspect of an embodiment, there is provided a storage system which includes a storage device and a control apparatus. The control apparatus sets an upper limit to write data size or read data size specified in commands for reading data from or writing data to the storage device, and sends the storage device a command whose write data size or read data size is restricted by the upper limit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a typical configuration and exemplary operation of a data storage system according to a first embodiment;

FIG. 2 illustrates an example of a data storage system according to a second embodiment;

FIG. 3 shows an exemplary hardware configuration of CM, as well as that of HDDs in DE;

FIG. 4 is a block diagram illustrating an example of processing functions of CM, as well as those of HDDs in DE;

FIG. 5 is a diagram that explains reordering of commands;

FIG. 6 illustrates details of processing functions of CM and exemplary operation of CM;

FIG. 7 is a flowchart illustrating exemplary processing performed by a RAID control unit;

FIG. 8 explains second command issuance control;

FIG. 9 is a flowchart illustrating exemplary processing of the second command issuance control;

FIG. 10 explains third command issuance control;

FIG. 11 explains how the execution order of commands is changed as the number of blocks varies;

FIG. 12 is a flowchart illustrating exemplary processing of the third command issuance control;

FIG. 13 explains fourth command issuance control;

FIG. 14 explains how the execution order of commands is changed depending on the queue mode;

FIG. 15 is a flowchart illustrating exemplary processing of the fourth command issuance control;

FIG. 16 is a flowchart illustrating exemplary processing performed by a disk control unit;

FIG. 17 is a flowchart illustrating a variation of the process of the RAID control unit; and

FIG. 18 is a flowchart illustrating exemplary processing performed by the RAID control unit according to a third embodiment.

### DESCRIPTION OF EMBODIMENTS

Several embodiments will be described below with reference to the accompanying drawings, wherein like reference numerals refer to like elements throughout.

### (a) First Embodiment

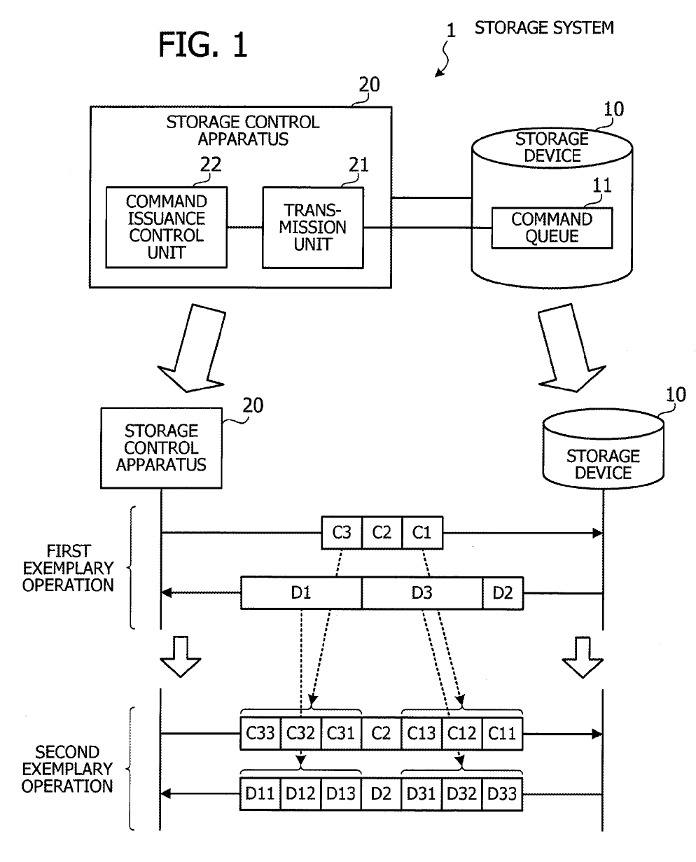

FIG. 1 illustrates a typical configuration and exemplary operation of a data storage system according to a first embodiment. The illustrated data storage system includes a storage device 10 and a storage control apparatus 20. The storage control apparatus 20 controls access to the storage device 10. The storage device 10 includes storage media such as HDDs. The storage device 10 writes data to or reads data from those storage media according to commands issued by the storage control apparatus 20.

The storage device 10 has a command reordering function that changes the execution order of received commands. For example, the storage device 10 has a command queue 11 as temporary storage of received commands. The storage device 10 reads commands from this command queue 11 one by one and executes requested operations specified in each such command. During this course, the storage device 10 changes the order of reading commands from the command queue 11 so as to reduce the execution time of the commands as a whole. In the case of HDDs, the storage device 10 changes the reading order such that the seek time and rotational latency of HDDs are minimized.

The storage control apparatus 20 controls access to the storage device 10 through the process of issuing relevant commands to the storage device 10. Included in the storage control apparatus 20 are a transmission unit 21 to send commands to the storage device 10 and a command issuance control unit 22 to control the way of issuing commands by the transmission unit 21. For example, the command issuance control unit 22 may set an upper limit for the size of write data or read data when issuing data write commands or data read commands to the storage device 10. The transmission unit 21 sends such size-restricted commands to the storage device 10, thus reducing the delay of command execution in the storage device 10.

As exemplary operations of the illustrated storage system 1, the following section will describe how data is read out of the storage device 10.

FIG. 1 illustrates a first exemplary operation in which the transmission unit 21 in the storage control apparatus 20 issues three read commands C1, C2, and C3 to the storage device 10 in that order. These read commands C1, C2, and C3 request reading of three pieces of data D1, D2, and D3 out of the storage device 10. Inside the storage device 10, the command queue 11 stores these commands C1, C2, and C3 in the order that they are received. The storage device 10 now determines in what order to execute the stored commands C1, C2, and C3. It is assumed here that data D1 and data D3 exceed the aforementioned upper limit of data size, while the second data D2 does not. It is also assumed that data D1 and data D3 are recorded in successive storage areas in the storage device 10, while data D2 is recorded in another storage area distant from the data D1 and D3.

Under the above conditions, the storage device 10 is likely to execute command C3, rather than command C2, after command C1 is finished. This would result in a larger execution delay of command C2. As the storage device 10 executes the commands C1, C3, and C2 in this way, three pieces of data D1, D3, and D2 are read out and transferred from the storage device 10 to the storage control apparatus 20 in that order.

The storage control apparatus 20 may also operate as illustrated as a second exemplary operation in FIG. 1. That is, the command issuance control unit 22 may switch the way of how the transmission unit 21 issues commands, such that an upper limit will be applied to the read data size of read commands. More specifically, the command issuance control unit 22 changes the way of command issuance such that data D1 will be read out as a collection of divided data D11, D12, and D13 each having a data size that does not exceed the given upper limit of data size. To this end, the transmission unit 21 issues commands C11, C12, and C13, instead of C1, to read data D11, D12, and D13, respectively. The command issuance control unit 22 also changes the way of command issuance such that data D3 is read out as a collection of divided data D31, D32, and D33 each having a data size that does not exceed the given upper limit. To this end, the transmission unit 21 issues commands C31, C32, and C33, instead of C3, to read such data D31, D32, and D33, respectively.

As a result of the above operation, a series of commands C11, C12, C13, C2, C31, C32, and C33 are issued from the transmission unit 21 to the storage device 10 in the second exemplary operation. These commands are subjected to reordering in the storage device 10. It is noted that the reordering mechanism has a general tendency to give priority to sequential access commands over random access commands, and most random access commands are directed to smaller data than that of sequential access commands.

Pending commands in the command queue 11 of the storage device 10 are supposed to include such random access commands and sequential access commands. The relative ratio of random access commands to sequential access commands will be increased by dividing a command with a large data size into a plurality of commands with a reduced data size, as illustrated in the second exemplary operation of FIG. 1. This feature makes it less likely for early-arriving commands to be executed later than others.

The number of pending commands in the command queue 11 increases as the data size per command is reduced. This means that the storage device 10 makes an increased number of decisions as to which command to select for the next execution. The frequent decisions may lead to more chances for random access commands to be executed earlier than before.

As can be seen from the above, the proposed system makes it less likely for random access commands to be executed later than others, and thus enables orderly execution of newly issued commands. The execution of command C2 in FIG. 1 demonstrates this effect. That is, the storage device 10 is more likely to execute command C2 before commands C31, C32, and C33 for divided portions D31, D32, and D33 of data D3, as opposed to the first exemplary operation. While not depicted in FIG. 1, the present embodiment may even increase the chance of executing command C2 before command C13 or C12, relative to the case of the first exemplary operation.

In the second exemplary operation described above, an upper limit is set to restrict the write data size and read data size specified in each command. This feature, on the other hand, produces an increased number of commands, which could degrade the efficiency of data access in the storage device 10. It is, therefore, inappropriate to apply the upper limit of data size to every command to be issued.

In view of the above, the command issuance control unit 22 is designed to determine whether to restrict the maximum size of write data or read data, depending on several conditions. For example, the command issuance control unit 22 may be configured to set an upper limit of write data size or read data size during a specified period after timeout of a command issued to the storage device 10. In other words, the upper size limit takes effect only when there is a long delay in the command execution. This upper size limit is expected to serve as a countermeasure to such delays.

The command issuance control unit 22 may also be configured to disable the above upper size limit when the number of pending commands in the command queue 11 of the storage device 10 reaches a specified threshold, even in the above-noted period after command timeout. This additional feature of the command issuance control unit 22 makes it possible to avoid further deterioration of processing efficiency in the storage device 10 due to increased pending commands in the command queue 11.

### (b) Second Embodiment

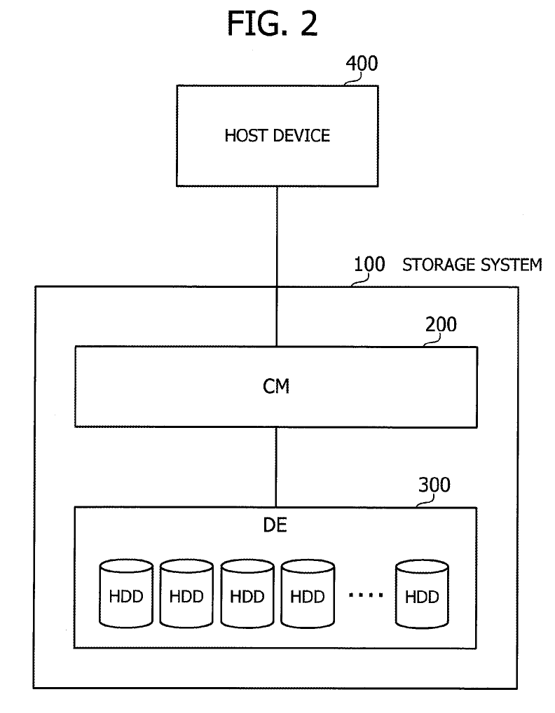

FIG. 2 illustrates an example of a data storage system according to a second embodiment. The illustrated storage system 100 includes a controller module (CM) 200 and a drive enclosure (DE) 300. A host device 400 is connected to the CM 200.

The CM 200 writes data to and reads data from storage devices in the DE 300 in response to input/output (I/O) requests from the host device 400. The storage devices in the DE 300 provide a physical storage space for such data. The CM 200 manages this physical storage space as RAID volumes, where RAID is the acronym for “Redundant Arrays of Inexpensive Disks.”

The DE 300 contains a plurality of storage devices to which access may be made from the CM 200. The second embodiment assumes that the DE 300 is a disk array system formed from a plurality of HDDs each having a command reordering function to optimize the execution order of commands received from the CM 200.

Upon receipt of a user input, the host device 400 requests the CM 200 to make access to HDDs in the DE 300. This access via the CM 200 may include the operation of reading data from HDDs, or writing data to HDDs, or both.

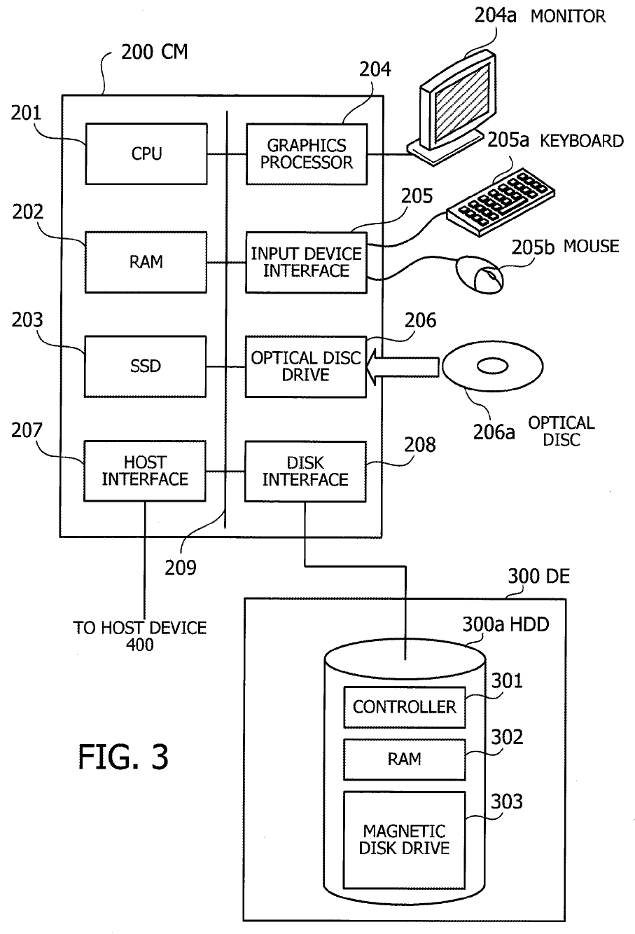

FIG. 3 shows an exemplary hardware configuration of CM, as well as that of HDDs in DE. The CM 200 includes a central processing unit (CPU) 201 to control the entire system of the CM 200. Connected to this CPU 201 via a bus 209 are random access memory (RAM) 202 and other various peripheral components. The RAM 202 serves as a primary storage device to store at least part of the software programs that the CPU 201 may execute, as well as various data used by the CPU 201 to execute those programs.

Other peripheral components connected to the CPU 201 are, for example, an SSD 203, a graphics processor 204, an input device interface 205, an optical disc drive 206, a host interface 207, and a disk interface 208.

The SSD 203 is used as a secondary storage device of the CM 200 to store software programs that the CPU 201 may execute, as well as various data used by the CPU 201 to execute the programs. Other kinds of non-volatile storage devices such as HDD may similarly serve as the secondary storage.

The graphics processor 204 produces video images in accordance with drawing commands from the CPU 201 and displays them on a screen of a monitor 204a coupled thereto. The monitor 204a may be, for example, a liquid crystal display.

The input device interface 205 is used to connect a keyboard 205a and a mouse 205b or other input devices to the CM 200. The input device interface 205 provides the CPU 201 with signals received from those input devices.

The optical disc drive 206 reads out data encoded on an optical disc 206a, by using laser light or the like. The optical disc 206a is a portable data storage medium, the data recorded on which can be read as a reflection of light or the lack of the same. The optical disc 206a may be a digital versatile disc (DVD), DVD-RAM, compact disc read-only memory (CD-ROM), CD-Recordable (CD-R), or CD-Rewritable (CD-RW), for example.

The host interface 207 performs interface functions to exchange data between the CM 200 and host device 400. The disk interface 208 performs interface functions to exchange data between the CM 200 and DE 300.

The DE 300 contains, on the other hand, HDDs 300a each including a controller 301, a RAM 302, and a magnetic disk drive 303. The controller 301 is a circuit including a CPU and other processing components configured to control the HDD 300a as a whole. The RAM 302 is used to store various data that the controller 301 manipulates during its processing. The magnetic disk drive 303 is formed from one ore more magnetic disks and writes data to and read data from those disks under the control of the controller 301.

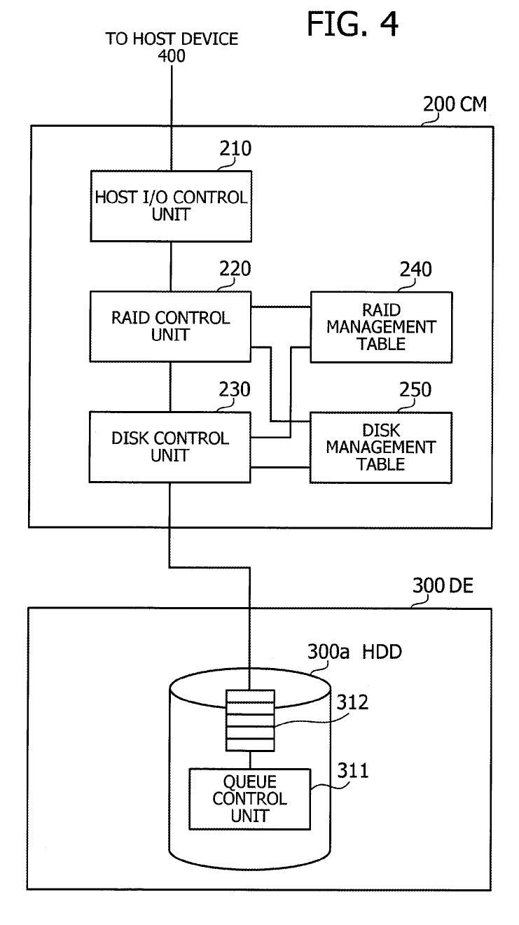

FIG. 4 is a block diagram illustrating an example of processing functions of CM, as well as those of HDDs in DE. The illustrated CM 200 includes, among others, a host I/O control unit 210, a RAID control unit 220, and a disk control unit 230. These components may be implemented as software programs executed by the CPU 201 in the CM 200.

The host I/O control unit 210 receives an I/O request (e.g., read request or write request) from the host device 400. The I/O request specifies a specific storage space provided by the HDDs in the DE 300. The host I/O control unit 210 controls this access from the host device 400 to that storage space in the DE 300, while using a part of RAM 202 in the CM 200 as a cache area for the data stored in or data to be written in the DE 300.

For example, the host I/O control unit 210 uses the cache memory area to temporarily store write data received as part of a data write request from the host device 400. The host I/O control unit 210 is configured to use a “write-back” policy when writing data. That is, given data is initially written only to the cache area, and the cached data is written to the DE 300 asynchronously with the initial writing. When executing a write back to the DE 300, the host I/O control unit 210 passes the write data to the RAID control unit 220.

The host I/O control unit 210 may also receive a data read request from the host device 400. In response, the host I/O control unit 210 determines whether the requested data resides in the cache area. In the case of a “cache hit” (i.e., the requested data is found in the cache area), the host I/O control unit 210 reads it out of the cache area and sends the read data to the host device 400. In the case of a “cache miss” (i.e., the requested data is not found in the cache area), the host I/O control unit 210 executes an operation to read the data in question from the DE 300. This operation is called “staging.” To initiate staging of data, the host I/O control unit 210 informs the RAID control unit 220 of the top address (or logical location) and data length, so that the RAID control unit 220 can retrieve the requested data from the DE 300. The host I/O control unit 210 sends the read data back to the host device 400, besides storing it in the cache area.

The RAID control unit 220 makes access to HDDs in the DE 300 via a disk control unit 230 in accordance with I/O requests from the host I/O control unit 210. The RAID control unit 220 manages the storage space provided by RAID-configured HDDs in the DE 300 with reference to a RAID management table 240 described below.

The RAID management table 240 contains information about one or more RAID groups. Specifically, the information includes the identifiers of HDDs constituting each RAID group and other management data indicating, for example, the RAID level of each group. The term “RAID group” refers to a logical storage space formed from physical memory areas on a plurality of HDDs mounted in the DE 300. For example, the host I/O control unit 210 may send a data write request for a specific RAID group. In response, the RAID control unit 220 controls writing of the specified data, together with some additional bits for redundancy purposes, based on the information stored in the RAID management table 240 for that RAID group. Suppose, for example, that the data write request received from the host I/O control unit 210 is directed a RAID group of four disk drives configured as RAID-5. In this case, the RAID control unit 220 divides the data into fixed-length segments and writes each three successive data segments, together with their parity, to four HDDs in such a way that the data segments will be distributed across storage spaces having the same stripe number.

Besides dividing the specified write data into segments and calculating parity of those segments, the RAID control unit 220 determines to which HDDs the divided data segments and calculated parity are supposed to go, by consulting the RAID management table 240 as described above. The RAID control unit 220 then requests the disk control unit 230 to write the data and parity to the determined HDDs.

The host I/O control unit 210 may also send a data read request. In response, the RAID control unit 220 determines which HDDs store the requested data, by consulting the RAID management table 240. The RAID control unit 220 then requests the disk control unit 230 to retrieve data from each of the determined HDDs.

The disk control unit 230 executes reading or writing of data by making access to specified HDDs in the DE 300 according to I/O requests from the RAID control unit 220. Specifically, the disk control unit 230 issues commands to the specified HDDs, thus causing the HDDs to execute what is described in those commands.

The basic operations of the RAID control unit 220 and disk control unit 230 have been described above. In addition, the RAID control unit 220 and disk control unit 230 may execute extra processing described below.

As illustrated in FIG. 4, a disk management table 250 is provided for reference by the RAID control unit 220, which indicates the current status of command execution in each HDD in the DE 300. Using this disk management table 250, the RAID control unit 220 may coordinate the way of issuing commands from the disk control unit 230 depending on the status of HDDs belonging to the RAID group to be accessed, so as to minimize the possible delay of their command execution. For example, the disk management table 250 may be created as a temporary object in the RAM 202 of the CM 200. The disk control unit 230 monitors execution of commands in each HDD of the DE 300 and updates HDD status information in the disk management table 250 to reflect the monitoring result. To this end, the disk control unit 230 may consult the RAID management table 240 discussed above.

While only one HDD is depicted in FIG. 4, the person skilled in the art would appreciate that the DE 300 may include a plurality of such HDDs. These HDDs in the DE 300 provide some functions described below. Specifically, the illustrated HDD 300a includes a queue control unit 311 and a command queue 312 coupled thereto. The queue control unit 311 may actually be implemented as processing functions of the foregoing controller 301 (see FIG. 3). The command queue 312 may be implemented as part of the RAM 302 (see FIG. 3).

The command queue 312 stores commands that the disk control unit 230 in the CM 200 has issued two the HDD 300a (referred to herein as the destination HDD). The controller 301 in the destination HDD 300a executes those commands by reading them one by one from the command queue 312. The queue control unit 311 is a processing block that implements command reordering functions. Specifically, the queue control unit 311 determines in what order to execute commands stored in the command queue 312.

Each command issued from the CM 200 may have a parameter that specifies which “queue mode” is to be applied (or what way of queuing is to be used) when the command is enqueued into the command queue 312. Specifically, the queue mode may be either “simple queue mode” or “ordered queue mode.” The queue control unit 311 in the destination HDD 300a is allowed to reorder the commands in simple queue mode. In contrast, the commands in ordered queue mode are supposed to be executed in the order that they are enqueued into the command queue 312 of the destination HDD 300a.

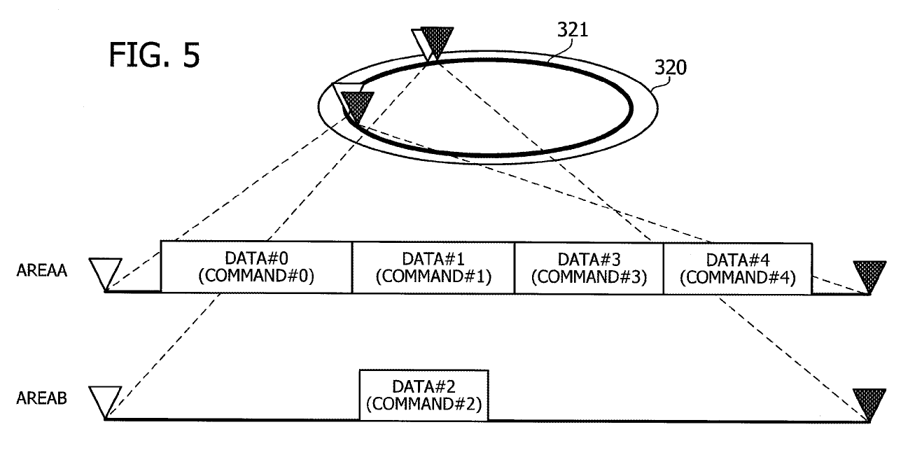

FIG. 5 is a diagram that explains reordering of commands. Pending commands in the command queue 312 include those set in the simple queue mode. The queue control unit 311 optimizes the execution order of this group of commands such that their respective processing operations finish in a short time. Basically, the queue control unit 311 identifies commands whose specified Logical Block Addresses (LBA) are relatively close to each other and arranges those commands for their back-to-back execution. The queue control unit 311 thus reduces the time for access to the desired data, such as the seek time of a magnetic head and rotational latency of magnetic disk platters.

Illustrated in FIG. 5 is a magnetic disk 320 in an HDD 300a, where data is recorded in two data areas A and B on a track 321. One data area A stores a series of data #0, #1, #3, and #4 without gaps. The other data area B stores data #2 whose size is smaller than data #0, #1, #3, and #4.

It is now assumed that the command queue 312 in the HDD 300a has received five commands in the following order: read command #0 for data #0, read command #1 for data #1, read command #2 for data #2, read command #3 for data #3, and read command #4 for data #4. Since data #2 is stored in a separate place from the former group of data #0, #1, #3, and #4, the queue control unit 311 determines to execute the commands #0, #1, #3, #4, and #2 in that order.

The above-described command reordering enables access to data with a shorter head seek time and rotational latency, thus improving the performance of HDD access. In other words, the read and write speeds are increased by the reordering of commands. This feature works effectively in recent storage systems in which an increasingly large number of commands are issued to HDDs as a result of the advancement of high-capacity HDDs and upsizing of the system. When executing such a large number of commands, the command reordering provides an enhanced efficiency with reduced read and write times.

The command reordering, on the other hand, has a drawback that some of the pending commands may be postponed for an extremely long time. This issue will be discussed in detail below.

With the reordering, some commands are executed earlier while other commands are delayed. One aspect of this distinction relates to the type of data access. Specifically, the commands received by the RAID control unit 220 are classified into those of sequential access and those of and random access, and in general, the reordering algorithm tends to give a higher priority to sequential access over random access. It is also known that random access commands are directed to smaller pieces of data in HDDs than sequential access commands.

Referring to the example of FIG. 5, the command queue 312 contains many sequential access commands such as the above-noted commands #0, #1, #3, and #4, together with a few random access commands such as the command #2. It is likely in this case that the execution of the random access commands is delayed. When a long series of such sequential access commands are issued to HDDs, the resulting delay of pending random access commands could amount to the extent that the CM 200 interprets it as a timeout of commands.

Some CMs have the function of counting errors during their HDD access and disabling an HDD when the number of errors detected in that HDD reaches a specified threshold. These CMs may be configured to count the timeout of commands as a kind of access errors. When such a CM experiences frequent timeout with a particular HDD as an adverse effect of the command reordering, the CM would mistakenly disable the HDD as being failed.

In view of the above, the CM 200 according to the second embodiment is designed to control the way of issuing commands to HDDs depending on the state of each HDD in the RAID group being accessed, so as to reduce the possibility of delay in the command execution while trying to maintain a high access performance.

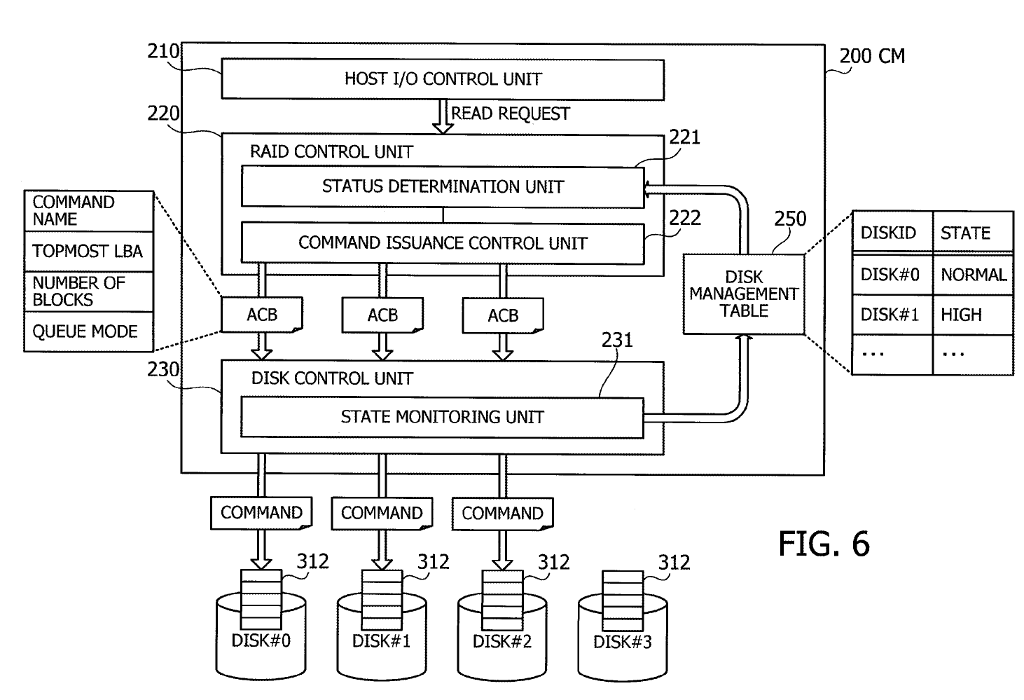

FIG. 6 illustrates the details of processing functions of a CM and exemplary operation of the CM. Specifically, FIG. 6 illustrates a CM 200 and a RAID group formed from four HDDs, referred to as disks #0 to #3. This example assumes that the CM 200 performs the aforementioned staging in response to a data read request. It is also assumed that the RAID group is configured in RAID level 5 (RAID-5) with a stripe depth of 0x80 blocks, where “0x” is a prefix denoting the hexadecimal numeral system. The term “block” refers to a unit area of HDDs which is designated by a specific LBA value. Data is striped across a plurality of HDDs that constitute a RAID group. The term “stripe depth” refers to the size of a stripe.

Referring to FIG. 6, the description begins with the basic process flow of reading data from disks #0 to #3. The received read request is passed from the host I/O control unit 210 to the RAID control unit 220. Upon receipt, the RAID control unit 220 identifies a RAID group that is relevant to the requested data. The RAID control unit 220 further determines in which HDDs the requested data is stored, with reference to the RAID management table 240.

In the example of FIG. 6, the requested data is divided into three segments and stored separately in three disks #0, #1, and #2, with their parity in disk #3. The RAID control unit 220 thus requests the disk control unit 230 to read data from each of the three disks #0, #1, and #2. This HDD access request from the RAID control unit 220 includes a set of control parameters called “Action Control Block” (ACB). The disk control unit 230 receives one ACB for each different HDD. Specifically, an ACB is formed from the following data fields: “Command Name,” “Topmost LBA,” “Block,” and “Queue Mode.” The command name field indicates the type of requested processing operation. The topmost LBA field indicates the top position of data that is accessed. The block field indicates the size of requested data in terms of the number of blocks, starting at the topmost LBA. The queue mode field specifies which of the foregoing two queue modes is used.

In the example of FIG. 6, the RAID control unit 220 provides the disk control unit 230 with three ACBs for reading data segments out of the three disks #0, #1, and #2. Based on these ACBs, the disk control unit 230 issues commands to each disk #0, #1, and #2. The commands include information described in the ACBs.

The issued commands go to command queues 312 in the receiving disks #0, #1, and #2 and are processed by their associated controllers 301. The requested data segments are read out of disks #0, #1, and #2 and transmitted to the CM 200. Inside the CM 200, the disk control unit 230 receives these data segments and forwards them to the RAID control unit 220. The RAID control unit 220 recombines the segments back to their original form and provides the resulting data to the host I/O control unit 210. Besides caching it in the RAM 202, the host I/O control unit 210 transmits the read data to the requesting host device 400.

The next section will describe a function for reducing the tendency of delaying command execution. To implement this function, the disk control unit 230 includes a state monitoring unit 231, and the RAID control unit 220 includes a status determination unit 221 and a command issuance control unit 222.

The state monitoring unit 231 observes accumulation and execution of commands in each HDD in the DE 300. Based on this observation, the state monitoring unit 231 determines the state of the HDD of interest, which may be “NORMAL” or “HIGH” or “TIMEOUT” state. More specifically, “HIGH” state means a high load condition in which the HDD has too many pending commands in its command queue 312. As will be described later, the state monitoring unit 231 chooses this HIGH state when the number of pending commands in an HDD reaches a predetermined threshold. Alternatively, the state monitoring unit 231 may do the same when the number of pending commands in an HDD of a particular RAID group exceeds, by a predetermined factor, the average number of pending commands in the HDDs belonging to that RAID group. “TIMEOUT” state means that the HDD has experienced a timeout of a command. As will be described later, the state monitoring unit 231 keeps the TIMEOUT state for a predetermined period after detection of a command timeout.

Note that the state monitoring unit 231 may find an HDD in both “HIGH” state and “TIMEOUT” state. The following part of the description will use the term “HIGH|TIMEOUT” to represent this combinational state.

Lastly, “NORMAL” state collectively refers to the other conditions than the above-noted HIGH, TIMEOUT, and HIGH|TIMEOUT. In other words, NORMAL state means that the load of the HDD in question is not particularly high, and thus exhibiting no large delays in its command execution.

Inside the RAID control unit 220, the status determination unit 221 may receive a read or write request from the host I/O control unit 210. In response, the status determination unit 221 consults the foregoing disk management table 250 to retrieve status information of HDDs to be accessed.

The retrieved status information is passed from the status determination unit 221 to the command issuance control unit 222. Based on this information, the command issuance control unit 222 produces ACBs for each HDD in the specific RAID group and supplies them to the disk control unit 230. More specifically, the command issuance control unit 222 controls issuance of commands from the disk control unit 230, depending on the status of each HDD in the RAID group being accessed, so as to reduce the possible delay of command execution without sacrificing the high access performance of the HDDs.

The operation of the proposed CM 200 will be described in greater detail below. It is assumed in the following section that data is read out of the DE 300 through the process of staging as in the example discussed in FIG. 6.

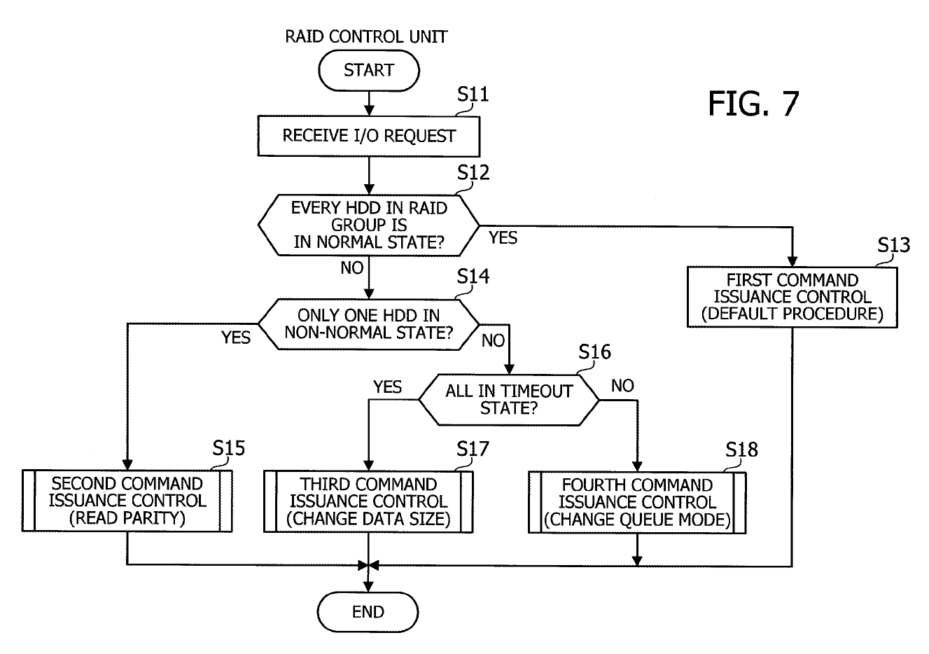

FIG. 7 is a flowchart illustrating exemplary processing performed by the RAID control unit 220. The RAID control unit 220 executes this process each time an I/O request (read request in FIG. 7) is received from the host I/O control unit 210.

(Step S11) The RAID control unit 220 receives a read request from the host I/O control unit 210.

(Step S12) The RAID control unit 220 identifies which RAID group contains the data specified in the read request. Suppose, for example, that the RAID group in question includes four HDDs, referred to as disk #0 to disk #3, configured as a RAID-5 array. Inside the RAID control unit 220, the status determination unit 221 consults the RAID management table 240 to determine which HDDs belong to the identified RAID group. The status determination unit 221 then retrieves information on the status of each relevant HDD from the disk management table 250 and determines whether all those HDDs are in NORMAL state. When they are all in NORMAL state, the process branches to step S13. When any of those HDDs indicates a state other than NORMAL, the process advances to step S14.

(Step S13) The command issuance control unit 222 in the RAID control unit 220 executes first command issuance control as its default operation in normal conditions. Specifically, the first command issuance control produces an ACB for each relevant HDD, or disks #0 to #3, to retrieve segmented data from the requested address. The produced ACBs are then sent from the command issuance control unit 222 to the disk control unit 230. Note that those ACBs specify the simple queue mode.

The command issuance control unit 222 waits for a response from the disk control unit 230 and receives data segments read out of disks #0 to #3. The command issuance control unit 222 then recombines the received segments and provides the host I/O control unit 210 with the resulting data.

(Step S14) The status information read out of the disk management table 250 at step S12 may indicate that one or more HDDs are not in the NORMAL state. The command issuance control unit 222 determines whether there is only one such HDD or more than one. When there is only one such HDD, the process advances to step S15. When there are two or more such HDDs, the process advances to step S16.

(Step S15) The command issuance control unit 222 executes second command issuance control. As will be described later, this second command issuance control prevents access to the single non-NORMAL HDD while allowing access to the other HDDs in the relevant RAID group. The command issuance control unit 222 may modify some ACBs to retrieve parity data, instead of the data segment in that non-NORMAL HDD. This parity data permits the command issuance control unit 222 to reproduce the original data through some computation, even in the absence of one data segment.

(Step S16) At step S12, the command issuance control unit 222 has retrieved status information of the relevant HDDs. The command issuance control unit 222 now determines whether the status information indicates that all the non-NORMAL HDDs are in TIMEOUT state. When it is found that all are in TIMEOUT state, the process advances to step S17. When that is not the case (i.e., at least one HDD is found to be in HIGH state or HIGH|TIMEOUT state), the process proceeds to step S18.

(Step S17) The command issuance control unit 222 executes third command issuance control. As will be described later, this third command issuance control controls access to HDDs so as to reduce the read data size per command (or the read blocks per command).

(Step S18) The command issuance control unit 222 executes fourth command issuance control. As will be described later, this fourth command issuance control changes the current queue mode to ordered queue mode when a random access pattern of commands is detected.

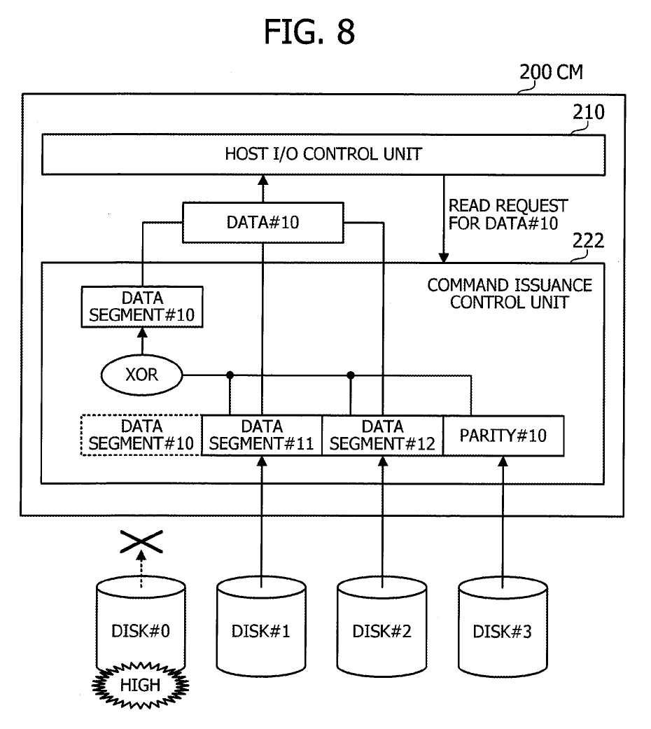

The details of the second to fourth command issuance control will be described below. To begin with, FIG. 8 explains how the second command issuance control works. It is assumed in this example that the host I/O control unit 210 requests the RAID control unit 220 to read data #10. Disks #0, #1, and #2 actually store the requested data #10 in a distributed manner; that is, data #10 is divided into three data segments #10, #11, and #12. More specifically, these data segments #10, #11, and #12 are stored in three separate storage areas having the same stripe number in disks #0, #1, and #2. In addition, parity data #10 is stored in a storage area of disk #3 which has the same stripe number as data segments #10 to #12. This parity data #10 was calculated previously from the data segments #10 to #12.

In its default procedure according to the first command issuance control (step S13 in FIG. 7), the command issuance control unit 222 in the RAID control unit 220 produces and supplies three ACBs to the disk control unit 230. Specifically, these ACBs are configured to cause the disk control unit 230 to issue the following three commands: (i) command for reading data segment #10 from disk #0, (ii) command for reading data segment #11 from disk #1, and (iii) command for reading data segment #12 from disk #2.

The status information at step S14 may indicate, for example, that disk #0 is in HIGH state while the other disks #1 to #3 are in NORMAL state. When this is the case, the command issuance control unit 222 executes second command issuance control (step S15 in FIG. 7). Unlike the above first command issuance control, the command issuance control unit 222 provides no ACB for data segment #10 in disk #0 in HIGH state, thus preventing the disk control unit 230 from making access to disk #0. The command issuance control unit 222 sends, instead, an ACB for reading parity data #10 in disk #3. The disk control unit 230 thus issues read commands to disks #1 to #3 and receives therefrom two data segments #11 and #12 and their associated parity data #10. The command issuance control unit 222 then applies some logical operations such as exclusive OR (XOR) to the data segments #11 and #12 and parity data #10, thereby reproducing the missing data segment #10. The command issuance control unit 222 further combines the reproduced data segment #10 with the received data segments #11 and #12 and supplies the reconstructed data #10 to the host I/O control unit 210.

As can be seen from the above, the second command issuance control purposefully stops sending commands to HDDs in non-NORMAL state. This feature of the command issuance control unit 222 helps these HDDs to reduce the amount of pending commands in their respective command queues 312. For example, an HDD in HIGH state may be able to return to NORMAL state and regain its original access speed, because no new commands are issued to the HDD during the HIGH state. The command issuance control unit 222 may also stop commands to HDDs in TIMEOUT state. These HDDs are encouraged to execute long-pending commands in their command queues 312, thus being able to escape from the timeout-prone situation.

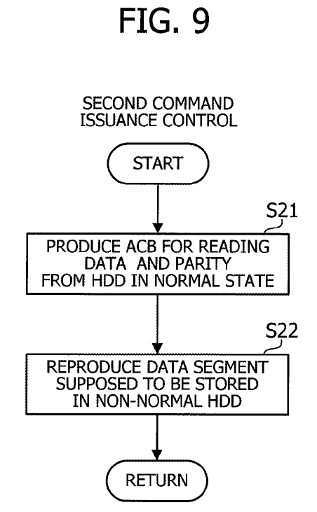

FIG. 9 is a flowchart illustrating exemplary processing of the second command issuance control. The context is that a particular RAID group, as well as its constituent HDDs, has been identified as being relevant to the received read request, where only one HDD is found not to be in NORMAL state (see FIG. 7).

(Step S21) The command issuance control unit 222 produces an ACB for each HDD in NORMAL state to read out data segments and their associated parity data. Here the command issuance control unit 222 specifies simple queue mode for these ACBs. The command issuance control unit 222 passes the produced ACBs to the disk control unit 230, thus requesting issuance of commands.

(Step S22) The command issuance control unit 222 receives data segments and their parity data from the disk control unit 230 which have been read out of the HDDs in NORMAL state in response to the issued commands. In the present context, one segment of the requested data is missing because its corresponding HDD is in non-NORMAL state. The command issuance control unit 222 reproduces the missing data segment by calculating it from the other data segments and parity data that share the same stripe number. The command issuance control unit 222 combines the reproduced data segment with the other data segments read out of their respective HDDs and passes the resulting data to the host I/O control unit 210.

While the above examples of FIGS. 8 and 9 have assumed that the RAID group is configured in RAID-5, the same description also applies to the case of RAID-4. In the case of RAID-6, the process discussed in FIG. 7 works almost similarly, with some modifications described below.

Specifically, the flowchart of FIG. 7 is modified as follows. The RAID control unit 220 proceeds from step S14 to step S15 when the determination at step S14 finds one or two HDDs in non-NORMAL state. Step S16 is taken when there are three or more such non-NORMAL HDDs. In the second command issuance control (FIG. 9) at step S15, the RAID control unit 220 issues no commands to the one or two HDDs in question because of their non-NORMAL state. This means a lack of one or two segments of the requested data. The RAID-6, however, permits the RAID control unit 220 to reproduce those missing data segments from other data segments read out of HDDs in NORMAL state, together with one or two pieces of parity data.

As can be seen from the above description, the number of HDDs that is tested at step S14 may be changed depending on how high degree of redundancy is implemented in the RAID group. More specifically, step S14 compares the number of non-NORMAL HDDs with a threshold that is equal to the number of parity records per stripe.

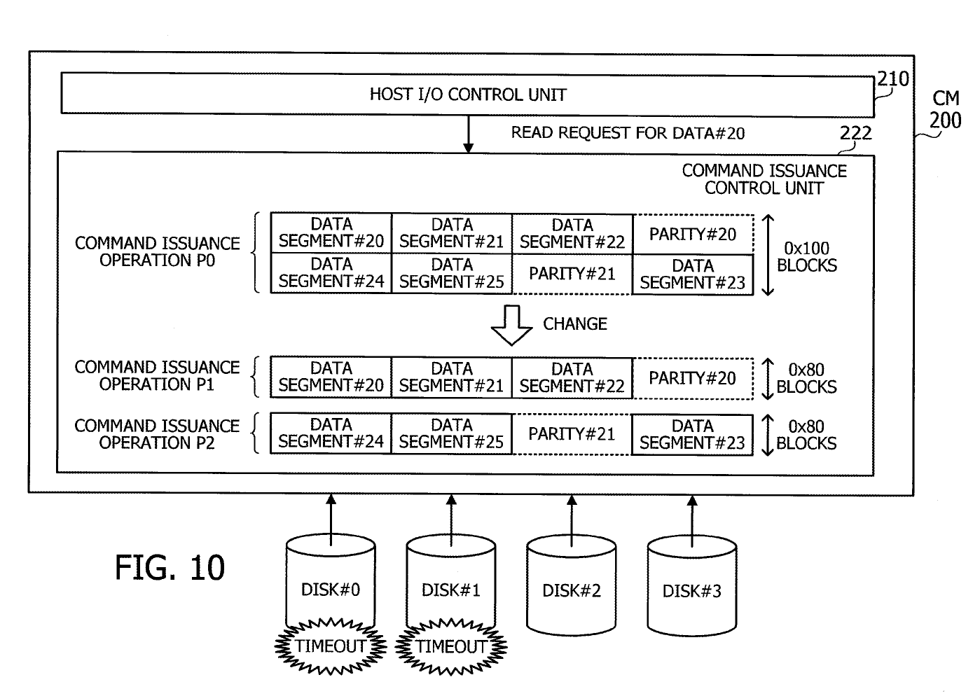

FIG. 10 now explains how the third command issuance control works. Referring to the example of FIG. 10, the host I/O control unit 210 requests the RAID control unit 220 to read data #20. It is assumed here that the requested data #20 is composed of six data segments #20 to #25. The first three data segments #20, #21, and #22 are respectively stored in three areas that share a first stripe number in different disks #0, #1, and #2. The second three data segments #23, #24, and #25 are respectively stored in three areas that share a second stripe number in different disks #3, #0, and #1. Disk #3 also has an area that shares the first stripe number with data segments #20 to #22, which stores parity data #20 calculated from the first three data segments #20 to #22. Similarly, disk #2 has an area that shares the second stripe number with data segments#23 to #25, which stores parity data #21 calculated from the second three data segments #23 to #25.

Command issuance operation P0 seen in FIG. 10 is an example of the foregoing first command issuance control (step S13 in FIG. 7) to be executed in normal conditions. In this command issuance operation P0, the command issuance control unit 222 in the RAID control unit 220 produces four ACBs to cause the disk control unit 230 to issue the following commands: (i) command for reading data segments #20 and #24 from disk #0, (ii) command for reading data segments #21 and #25 from disk #1, (iii) command for reading data segment #22 from disk #2, and (iv) command for reading data segment #23 from disk #3. The command issuance control unit 222 sends these ACBs to the disk control unit 230. The disk control unit 230 thus issues a command to each disk to request reading data. Note here that the disks #0 and #1 are each requested to read data that is larger than the stripe depth (0x80 blocks).

The above is not always the case. The command issuance control unit 222 chooses the third command issuance control as in step S17 of FIG. 7, when step S16 finds two disks #0 and #1 to be in TIMEOUT state while the other disks #2 and #3 are in NORMAL state. In this case, the command issuance control unit 222 controls commands addressed to at least two disks #0 and #1, so as to reduce the read data size that one command can specify (or the number of read blocks per command). According to the present embodiment, the command issuance control unit 222 controls the number of read blocks per command for each HDD within an upper limit of, for example, 0x80 blocks. This upper limit corresponds to the stripe depth in terms of block count.

More specifically, the command issuance control unit 222 causes the disk control unit 230 to issue two separate commands to disk #0, one for reading data segment #20 and the other for reading data segment #24. FIG. 10 depicts this in two command issuance operations P1 and P2. The command issuance control unit 222 provides the disk control unit 230 with two ACBs for issuance of the former and latter commands.

The command issuance control unit 222 also causes the disk control unit 230 to issue two separate commands to disk #1, one for reading data segment #21 and the other for reading data segment #25. For this purpose, the command issuance control unit 222 provides the disk control unit 230 with two more ACBs for issuance of the former and latter commands.

There is no particular need, on the other hand, for reading parity data #20 and #21 from HDDs in the present example. However, the command issuance control unit 222 may be configured to request the disk control unit 230 to issue the following commands: (i) command for reading data segment #22 from disk #2, (ii) command for reading parity data #21 from disk #2, (iii) command for reading parity data #20 from disk #3, and (iv) command for reading data segment #23 from disk #3. This feature equalizes the number of commands issued to different HDDs and makes the management of commands easier.

As mentioned previously in FIG. 5, the reordering mechanisms have a tendency to postpone read commands for smaller data (i.e., fewer blocks) in HDDs. Referring to the case of FIG. 10, two disks #0 and #1 are in TIMEOUT state. This fact implies that their command queues 312 contain more sequential access commands than random access commands, because the sequential access commands are supposed to read a relatively large number of blocks, whereas the random access commands are supposed to read a relatively small number of blocks. It is suspected that the random access commands issued to the disks #0 and #1 have long been waiting their turn in the command queues 312. If an additional sequential access command is issued to read two data segments #20 and #24 at a time, the disk #1 has to further postpone the execution of those long-pending random access commands.

To avoid the above situation, the third command issuance control manages the commands so as to reduce the number of blocks that are read out of HDDs per command. This feature reduces the chances of command execution delay.

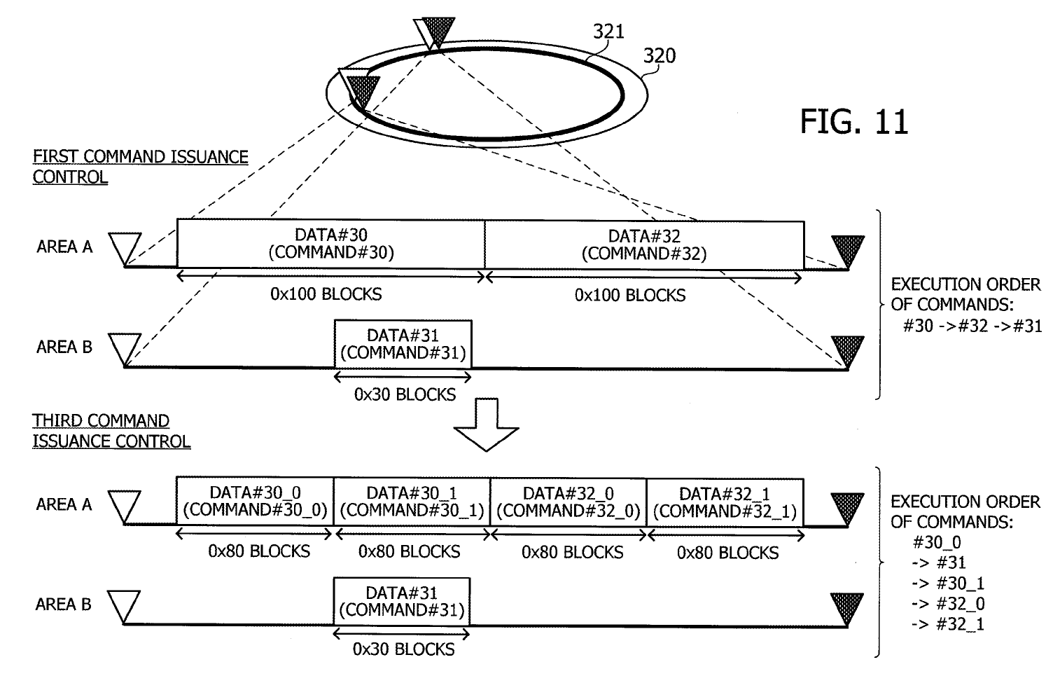

FIG. 11 explains how the execution order of commands is changed as the number of read blocks varies. In this example, data is recorded in two data areas A and B on a specific track 321 of a magnetic disk 320, as in the HDD discussed in FIG. 5.

Referring to the example of FIG. 11, one data area A stores two chunks of data #30 and #32 in series, while another data area B stores data #31. Data #30, as well as data #32, is 0x100 blocks in length. This is twice as long as the stripe depth. Data #31, on the other hand, is 0x30 blocks in length, which is smaller than the stripe depth. Suppose now that the host I/O control unit 210 outputs three requests to the RAID control unit 220 for reading these pieces of data #30, #31, and #32 in this order.

As one option, the RAID control unit 220 may handle the above requests with the first command issuance control. When this is the case, the command issuance control unit 222 causes the disk control unit 230 to issue three commands #30, #31, and #32 in that order, according to the requests for data #30, #31, and #32. Since data #32 is located immediately next to data #30 in the HDD, the queue control unit 311 is likely to execute commands #30, #32, and #31 in this order.

As another option, the RAID control unit 220 may handle the requests with the third command issuance control. When this is the case, the command issuance control unit 222 causes the issuance of two commands for reading data #30 in two halves, data #30_0 and data #30_1, each being 0x80 blocks in length. The command issuance control unit 222 similarly causes the issuance of two commands for reading data #32 in two halves, data #32_0 and data #32_1, each being 0x80 blocks in length. This control results in five read commands accumulated in the command queue 312 of HDD in the following order: (i) command #30_0 for data #30_0, (ii) command #30_1 for data #30_1, (iii) command #31 for data #31, (iv) command #32_0 for data #32_0, and (v) command #32_1 for data #32_1.

As can be seen from the above, the third command issuance control reduces the size of data to be read in each command. As the data size per command decreases, the pending random access commands increases their share in the command queue 312 of the HDD. In other words, the share of sequential access commands in the command queue 312 decreases in spite of their potential priority in the execution. The resulting execution order is less likely to defer the execution of early-arriving commands.

With the above control, the queue control unit 311 does not always execute command #30_1 after command #30_0, but may decide to execute command #31 in the first place and then proceed to other commands #30_1, #32_0, and #32_1. Another possibility for the queue control unit 311 is to execute commands #30_0 and #30_1 in the first place and then proceed to command #31.

Basically the queue control unit 311 in HDDs schedules successive execution of read commands if the specified data areas are close to each other in the LBA space. This is, however, not the only rule that the queue control unit 311 applies. For example, the queue control unit 311 may schedule a plurality of commands so as to reduce the total execution time of the commands as a whole. This is why the queue control unit 311 does not always execute command #30_1 after command #30_0, but may decide to execute command #31 in the first place and then proceed to other commands #30_1, #32_0, and #32_1 as described above.

The effect of the third command issuance control may also be explained in the following way. A reduced data size per command leads to an increased number of pending commands in the command queue, which causes the queue control unit 311 to make more frequent decisions as to which command to execute next. This produces increased chances of earlier execution of random access commands than in the case of the first command issuance control.

The above description of FIG. 11 assumes that three requests for data #30 to #32 are handled by the same CM 200. In another case, different CMs may request data #30 to #32. Suppose, for example, one CM sends read requests for data #30 and #32 while another CM sends a request for data #31. If the former CM applies the third command issuance control, a series of commands #30_0, #31, #30_1, #32_0, and #32_1 will build up in the command queue 312 in that order. In this case the HDD is more likely to execute command #31 before command #30_1.

The above-described third command issuance control reduces the number of read blocks per command in the command queue 312, thus making random access commands less prone to delay or timeout. Even when some random access commands are seriously delayed, the third command issuance control prevents them from suffering a further delay.

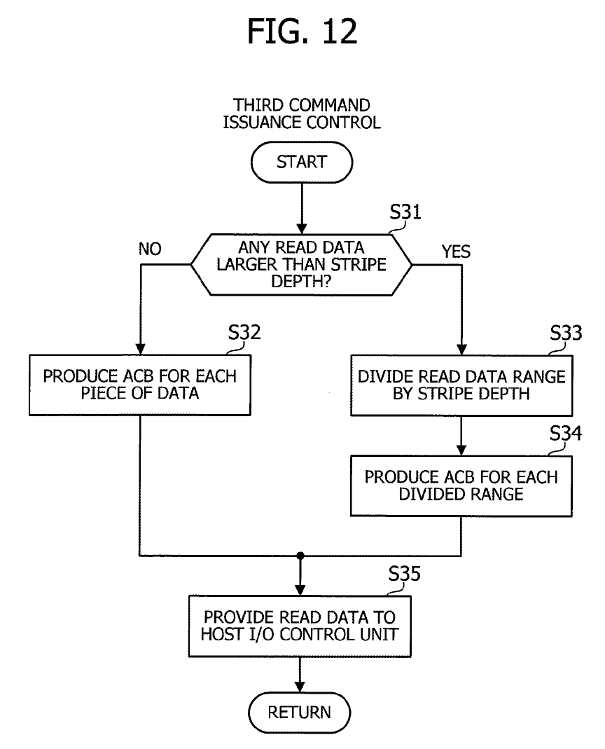

FIG. 12 is a flowchart illustrating exemplary processing of the third command issuance control. The context is that a particular RAID group, as well as its constituent HDDs, has been identified as being relevant to the received read request, where two or more HDD are found to be in TIMEOUT state (see FIG. 7).

(Step S31) The command issuance control unit 222 examines the size of data to be read out of each HDD in the RAID group and determines whether there is any data larger than the stripe depth. When no such data is found, the process advances to step S32. When such data is found, the process advances to step S33.

(Step S32) The command issuance control unit 222 produces an ACB for each relevant HDD to read the requested data out of the identified RAID group. Here the command issuance control unit 222 specifies simple queue mode for these ACBs. The command issuance control unit 222 passes the produced ACBs to the disk control unit 230, thus requesting issuance of commands.

(Step S33) Referring to the data found to be larger than the stripe depth at step S31, the command issuance control unit 222 divides the range of that large data by the stripe depth.

(Step S34) The command issuance control unit 222 produces an ACB for reading data from each divided range obtained at step S33. This step S34 thus produces a plurality of ACBs for the HDD containing the large data. The command issuance control unit 222 also produces ACBs as in step S32 for the other data, whose size is smaller than or equal to the stripe depth. Here the command issuance control unit 222 specifies simple queue mode for these ACBs. The command issuance control unit 222 passes the produced ACBs to the disk control unit 230, thus requesting issuance of commands.

(Step S35) The command issuance control unit 222 receives data segments from the disk control unit 230 which have been read out of the HDDs according to the issued commands. The command issuance control unit 222 then combines the received data segments and provides the host I/O control unit 210 with the resulting data.

According to the above procedure of the third command issuance control, the command issuance control unit 222 uses the stripe depth as an upper limit to the number of blocks that one command is allowed to specify. This upper limit is applied to every HDD in the identified RAID group which contains data segments larger than the stripe depth. As a variation, the upper limit of blocks per command may be applied, not to every such HDD, but only to the HDDs whose status is marked “TIMEOUT.”

As discussed in FIG. 5, the present embodiment is configured to perform the third command issuance control by the command issuance control unit 222 when the identified RAID group includes a plurality of HDDs in TIMEOUT state while the others are in NORMAL state. As a possible variation, the embodiment may be modified to use the third command issuance control, instead of the second command issuance control, when the identified RAID group includes one HDD in TIMEOUT state while the others are in NORMAL state. In this variation, the third command issuance control may apply the above-noted upper limit only to the HDD in TIMEOUT state, so that the number of read blocks per command does not exceed the stripe depth.

The following section will describe fourth command issuance control. As described in the flowchart of FIG. 7, the command issuance control unit 222 proceeds to fourth command issuance control of step S18 when even a single one of the non-NORMAL HDDs indicates a HIGH or HIGH|TIMEOUT state at step S16. These HDDs are experiencing an excessive amount of load due to many pending commands in their command queues, and hence the HIGH or HIGH|TIMEOUT state. The third command issuance control may be unable to work well in this case because it would place more commands (i.e., more load) on the heavily-loaded HDDs.

In view of the above, the command issuance control unit 222 executes the following fourth command issuance control. Briefly, the fourth command issuance control causes the command issuance control unit 222 to change the queue mode of commands from simple queue mode to ordered queue mode, depending on whether the access to HDDs exhibits a sequential pattern or a random pattern.

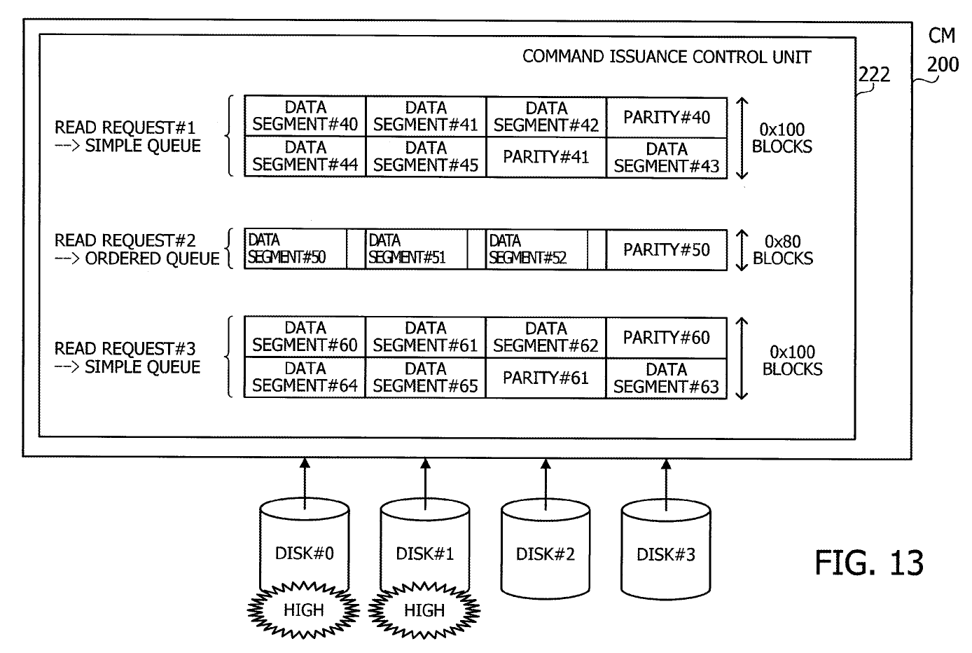

FIG. 13 explains how the fourth command issuance control works. It is assumed in this example that the host I/O control unit 210 has made a series of read requests #1, #2, and #3 to the RAID control unit 220. It is also assumed in FIG. 13 that the intended RAID group includes disks #0 and #1 in HIGH state and disks #2 and #3 in NORMAL state.

Read request #1 specifies data that is actually formed from six data segments #40 to #45. The first three data segments #40, #41, and #42 are respectively stored in three areas that share a first stripe number in different disks #0, #1, and #2. The second three data segments #43, #44, and #45 are respectively stored in three areas that share a second stripe number in different disks #3, #0, and #1. Disk #3 also has an area that shares the first stripe number with data segments #40 to #42, which stores parity data #40 calculated from the data segments #40 to #42. Similarly, disk #2 has an area that shares the second stripe number with data segments#43 to #45, which stores parity data #41 calculated from the data segments#43 to #45.

Read request #2, on the other hand, specifies data that is actually formed from three data segments #50, #51, and #52 stored in disks #0, #1, and #2, respectively. These data segments #50, #51, and #52 are each smaller than the stripe depth, meaning that the second read request #2 requests reading data from discrete storage areas. In addition, parity data #50 is stored in a storage area of disk #3 which has the same stripe number as data segments #50 to #52. This parity data #50 has been calculated from the data segments #50 to #52.

Read request #3 specifies data that is actually formed from six data segments #60 to #65. The first three data segments #60, #61, and #62 are respectively stored in three areas that share a third stripe number in different disks #0, #1, and #2. The second three data segments #63, #64, and #65 are respectively stored in three areas that share a fourth stripe number in different disks #3, #0, and #1. Disk #3 also has an area that shares the third stripe number with data segments #60 to #62, which stores parity data #60 calculated from the data segments #60 to #62. Similarly, disk #2 has an area that shares the fourth stripe number with data segments#63 to #65, which stores parity data #61 calculated from the data segments#63 to #65.

According to the fourth command issuance control, the command issuance control unit 222 in the RAID control unit 220 determines the access type of each read request addressed to HDDs. The read requests are classified into two access types, one being sequential access and the other being random access. For example, the command issuance control unit 222 finds that a given read request is in the nature of random access, when the size of read data in every HDD is smaller than or equal to the stripe depth. More specifically, the command issuance control unit 222 handles the above-noted read requests #1, #2, and #3 as follows:

Upon receipt of read request #1, the command issuance control unit 222 produces four ACBs configured to cause the disk control unit 230 to issue the following commands: (i) command for reading data segments #40 and #44 from disk #0, (ii) command for reading data segments #41 and #45 from disk #1, (iii) command for reading data segment #42 from disk #2, and (iv) command for reading data segment #43 from disk #3. The command issuance control unit 222 sends these ACBs to the disk control unit 230. It is noted that the data segments in disks #0 and #1 are greater than the stripe depth. The command issuance control unit 222 thus specifies simple queue mode for the four ACBs.

Upon receipt of read request #2, the command issuance control unit 222 produces three ACBs configured to cause the disk control unit 230 to issue the following commands: (i) command for reading data segment #50 from disk #0, (ii) command for reading data segment #51 from disk #1, and (iii) command for reading data segment #52 from disk #2. The command issuance control unit 222 sends these ACBs to the disk control unit 230. It is noted that all those data segments are smaller than the stripe depth. The command issuance control unit 222 thus specifies ordered queue mode for the three ACBs.

Upon receipt of read request #3, the command issuance control unit 222 operates similarly to the case of read request #1 discussed above. That is, the command issuance control unit 222 specifies simple queue mode for the commands since the data segments in disks #0 and #1 are greater than the stripe depth.

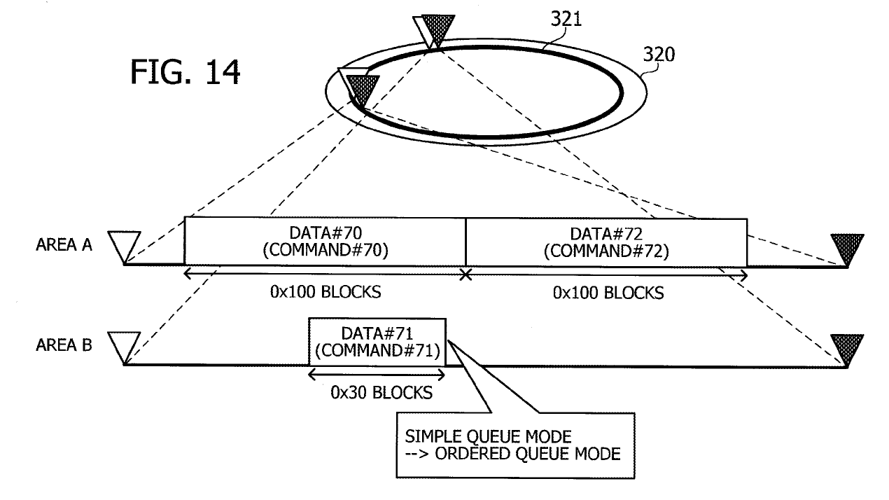

FIG. 14 explains how the execution order of commands is changed depending on the queue mode. In this example, data is recorded in two data areas A and B on a specific track 321 of a magnetic disk 320, as in the HDD discussed in FIG. 5.

Referring to the example of FIG. 14, one data area A stores two chunks of data #70 and #22 in series, while the other data area B stores data #71. Data #70, as well as data #72, is 0x100 blocks in length. This is twice as long as the stripe depth. Data #71, on the other hand, is 0x30 blocks in length, which is smaller than the stripe depth. The command issuance control unit 222 in the RAID control unit 220 causes the three commands #70, #71, and #72 to be issued in that order to read data #70, #71, and #72.

According to the fourth command issuance control, the command issuance control unit 222 specifies ordered queue mode for command #71 while specifying simple queue mode for commands #70 and #72. If all those commands are equally set to simple queue mode, the receiving HDD is likely to execute command #70 in the first place, command #72 in the second place, and command #71 in the third place. In contrast, the fourth command issuance control specifies ordered queue mode for command #71, thus ensuring execution of command #71 before command #72.

In this way, the fourth command issuance control changes the queue mode of commands according to their access patterns, rather than increasing commands as in the third command issuance control, when some HDDs are in high-load conditions. Since there is no change in the number of commands, those heavily-loaded HDDs escape from an additional burden of increased commands.

Note that the command issuance control unit 222 specifies ordered queue mode, not for all commands to be issued, but only for random access commands. In other words, the ordered queue mode is applied only to the commands that are prone to execution delays. Sequential access commands, on the other hand, are issued without change in the queue mode, i.e., using simple queue mode as their default queue mode, so that the reordering functions in HDDs effectively work with those sequential access commands.

When the fourth command issuance control is taken, random access commands in ordered queue mode may be more affected by the seek time and rotational latency of HDDs, compared with the third command issuance control. This nature of the fourth command issuance control could lead to slower read operation in random access. Sequential access commands, on the other hand, are not subject to change of queue mode since their execution is not delayed by the reordering. In other words, the above slowdown factors have only a limited effect on the sequential access commands. The fourth command issuance control therefore reduces the probability of command timeout while alleviating slowdown of data read from HDDs.

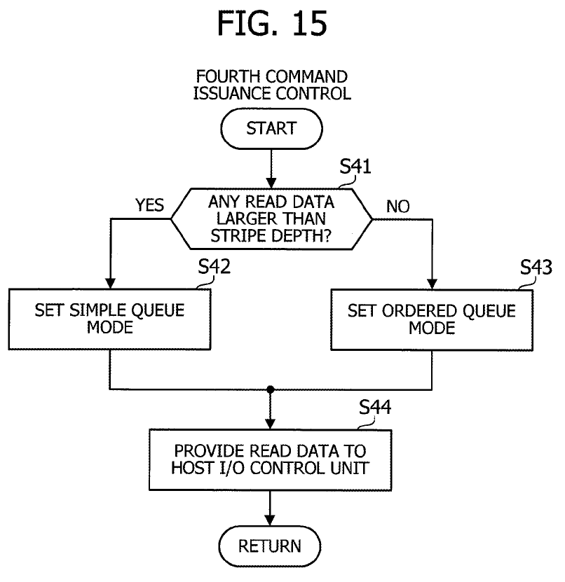

FIG. 15 is a flowchart illustrating exemplary processing of the fourth command issuance control. The context is that a particular RAID group, as well as its constituent HDDs, has been identified as being relevant to the received read request, where some HDDs are found to be in HIGH or HIGH|TIMEOUT state (see FIG. 7).

(Step S41) The command issuance control unit 222 checks the size of data to be read out of each HDD in the identified RAID group, thus determining whether there is any data larger than the stripe depth. When no such data is found, the process advances to step S43. When at least one such large chunk of data is found, the process advances to step S42.

(Step S42) The command issuance control unit 222 produces an ACB for each relevant HDD to read the requested data out of HDDs in the identified RAID group. Here the command issuance control unit 222 specifies simple queue mode for these ACBs. The command issuance control unit 222 passes the produced ACBs to the disk control unit 230, thus requesting issuance of commands.

(Step S43) The command issuance control unit 222 produces an ACB for each relevant HDD to read requested data out of the HDDs in the identified RAID group. Here the command issuance control unit 222 specifies ordered queue mode for these ACBs. The command issuance control unit 222 passes the produced ACBs to the disk control unit 230, thus requesting issuance of commands.

(Step S44) The command issuance control unit 222 receives data segments from the disk control unit 230 which have been read out of the HDDs according to the issued commands. The command issuance control unit 222 then combines the received data segments and provides the host I/O control unit 210 with the resulting data.

The command issuance control unit 222 in the RAID control unit 220 selectively executes the above-described second to fourth command issuance control, depending on the status of HDDs in a relevant RAID group. This feature of the command issuance control unit 222 avoids extra delay of command execution and consequent timeout of particular commands, without sacrificing access performance of each HDD.

The disk control unit 230 may have a function of counting error scores of each HDD, including timeout of commands. When the error score reaches a predetermined threshold, the disk control unit 230 interprets it as indicating a defective HDD and thus removes that HDD from its RAID group. The above-noted feature of the command issuance control unit 222 prevents the error score from unduly increasing. That is, the above-described adaptive use of the second to fourth command issuance control makes it less likely that an HDD is forced out of its RAID group due to a delay of command execution which is caused by other than the HDD's failure.

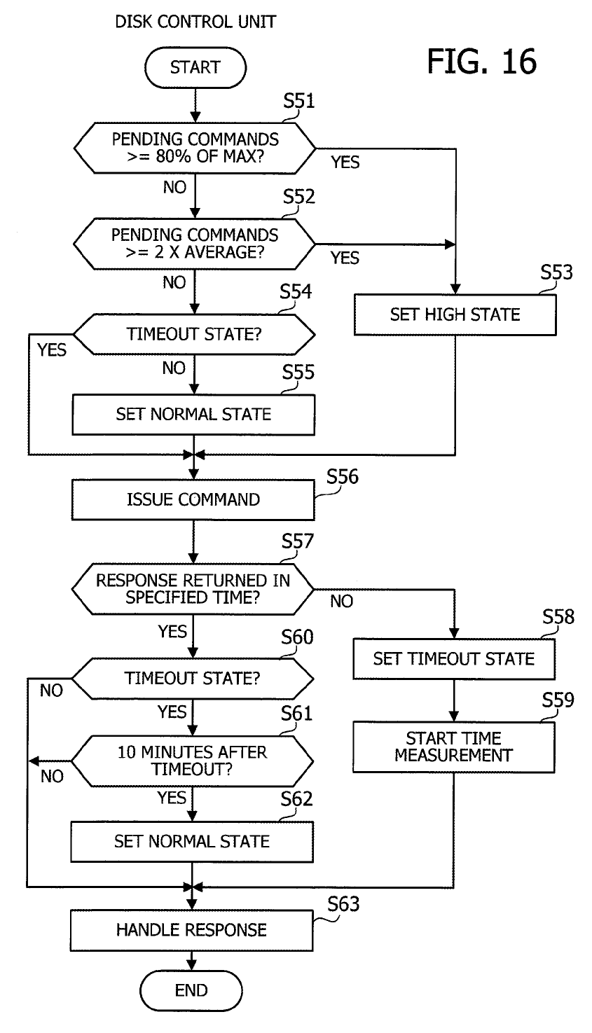

FIG. 16 is a flowchart illustrating exemplary processing performed by the disk control unit 230. This procedure of FIG. 16 is executed each time a new ACB is received from the RAID control unit 220 according to the procedure of FIG. 7. In other words, the following procedure is executed for each particular HDD that is accessed. The following steps refers to such an HDD as “the HDD of interest” or simply “the HDD.”

(Step S51) The state monitoring unit 231 in the disk control unit 230 determines whether the number of pending commands accumulated in the command queue 312 of the HDD of interest has reached, for example, 80% of its maximum capacity. When the number of pending commands is less than 80% of the maximum, the process advances to step S52. If it is 80% or more, the process executes step S53.

For example, the disk control unit 230 keeps track of the number of ACBs that are received from the RAID control unit 220 but still incomplete in the HDD (i.e., response has not been returned from the HDD). This ACB count represents the number of pending commands accumulated in the command queue 312 of the HDD. It is also noted that the threshold used in step S51 is not limited to 80%, but any other percentage may be used.

(Step S52) With reference to the RAID management table 240, the state monitoring unit 231 identifies to which RAID group the HDD of interest belongs, and calculates an average number of pending commands in the command queues 312 of all HDDs that belong to the identified RAID group.

The state monitoring unit 231 may find that the number of pending commands in the HDD of interest is greater than or equal to twice the calculated average. When this is the case, the state monitoring unit 231 interprets it as indicating that the distribution of pending commands within the RAID group is quite uneven, and particularly that the HDD of interest is experiencing a heavier load than others. This condition brings the process to step S53. On the other hand, when the number of pending commands is smaller than twice the average, the process proceeds to step S54. It is noted that the threshold used in this step S52 is not limited to twice the average, but may be other appropriate values.

(Step S53) When the branch of YES is taken at step S51 or S52, it means the presence of an excessive load on the HDD of interest. Accordingly the state monitoring unit 231 updates the entry of the HDD of interest in the disk management table 250 by changing its status field from NORMAL to HIGH, or from TIMEOUT to HIGH|TIMEOUT. When the current status is already HIGH or HIGH|TIMEOUT, the state monitoring unit 231 maintains the status field as is.

(Step S54) With reference to disk management table 250, the state monitoring unit 231 determines whether the HDD of interest is in TIMEOUT state. When the HDD is in TIMEOUT state, the process skips to step S56. When it isn't (i.e., the HDD is in NORMAL, HIGH, or HIGH|TIMEOUT state), the process advances to step S55.

(Step S55) The fact that the branch of NO is taken at both steps S51 and S52 indicates that the HDD of interest is not heavily loaded. Accordingly the state monitoring unit 231 updates the entry of the HDD of interest in the disk management table 250 by changing its status field from HIGH to NORMAL, or from HIGH|TIMEOUT to TIMEOUT. When the current status is NORMAL, the state monitoring unit 231 maintains the status field as is.

(Step S56) Based on the ACB received from the RAID control unit 220, the disk control unit 230 issues a command to the HDD of interest.

(Step S57) Counting the time since the command issuance at step S56, the state monitoring unit 231 determines whether the HDD has responded to the command within a specified time. When a response is returned from the HDD in the specified time, the process advances to step S60. When there is no response, the process executes step S58.

(Step S58) The state monitoring unit 231 interprets the lack of response as a timeout of the issued command, thus updating the entry of the HDD in the disk management table 250 by changing its status field from NORMAL to TIMEOUT, or HIGH to HIGH|TIMEOUT. When the current status is TIMEOUT or HIGH|TIMEOUT, the state monitoring unit 231 maintains the status field as is.

(Step S59) The state monitoring unit 231 starts counting the time since the execution of step S56. In the case where the above step S58 finds that the HDD of interest has already been in TIMEOUT or HIGH|TIMEOUT state, the state monitoring unit 231 resets the time count and restarts the counting. In other words, step S59 starts counting the elapsed time since the last detection of a timeout of the HDD.

(Step S60) The state monitoring unit 231 consults the disk management table 250 to check the current status of the HDD. When the status field indicates TIMEOUT or HIGH|TIMEOUT state of the HDD, the process advances to step S61. When the status field indicates NORMAL or HIGH state, the process skips to step S63.

(Step S61) The state monitoring unit 231 checks the elapsed time since the last detection of a timeout of the HDD. When the elapsed time is equal to or longer than 10 minutes, the process advances to step S62. When the elapsed time is shorter than 10 minutes, the process skips to step S63. The threshold used in this step S61 is not limited to 10 minutes, but any other time length may be used.

(Step S62) The state monitoring unit 231 updates the entry of the HDD in the disk management table 250 by changing its status field from TIMEOUT to NORMAL, or from HIGH|TIMEOUT to HIGH.

(Step S63) The disk control unit 230 returns a response to the RAID control unit 220, depending on the overall result of step S56. Specifically, when the HDD has responded to the command issued at step S56 within a specified time (i.e., in the case of YES at step S57), the disk control unit 230 passes the read data of the HDD to the RAID control unit 220. When the specified time has elapsed without response from the HDD (i.e., in the case of No at step S57), the disk control unit 230 notifies the RAID control unit 220 that the issued command corresponding the ACB received therefrom has ended up with a timeout.

In the above flowchart, the state monitoring unit 231 watches a response of an issued command for a specified time (steps S57 to S62). When no response is returned within that time, the state monitoring unit 231 updates the status to indicate the timeout (step S58). While this timeout-causing situation may be resolved in time, the state monitoring unit 231 keeps the status of timeout for a certain period after the last detection of timeout (as in the case of NO at step S61)

As mentioned previously, the disk control unit 230 may have a function of counting error scores of each HDD. For example, the disk control unit 230 may add a certain point to the error score of an HDD when an error is detected during access to the HDD. The amount of this point may vary depending on what kind of error it is. The disk control unit 230 may also be configured to reset the error score of an HDD to zero a certain time after the last detection of error. This is because the absence of errors for a while implies that the previous error might have been caused by some transitory factor.

Timeout of commands may be treated as an error in the above error scoring and reset functions. When these functions are implemented together with the disk control of FIG. 16, step S61 of checking the elapsed time since timeout detection may also be used to determine whether to reset error scores. Similarly, the threshold used at step S61 for determining the elapsed time may also serve as the threshold for determining whether to reset error scores.

As mentioned above in the description of FIG. 16, the state monitoring unit 231 keeps the status of timeout for a certain time after the last detection of timeout, even if the timeout-causing situation no longer persists. This operation of the state monitoring unit 231 ensures that at least one of the HDDs constituting a RAID group is in TIMEOUT state or HIGH|TIMEOUT state for a certain period after the last detection of timeout in the RAID group. During that period, the command issuance control unit 222 in the RAID control unit 220 continues to use the second, third, or fourth command issuance control for unusual conditions. This feature makes it more likely for the RAID group to get out of the situation where a command queue is clogged with many pending commands, or there is a large delay in the execution of issued commands.

In the example of FIG. 16, the use of second to fourth command issuance control is continued for a certain time after the last detection of timeout. The present embodiment may, however, be modified such that the command issuance control unit 222 keeps using the same type of command issuance control during a certain period after the first use of the second, third, or fourth command issuance control. The following section will describe an example of this variation of the embodiment.

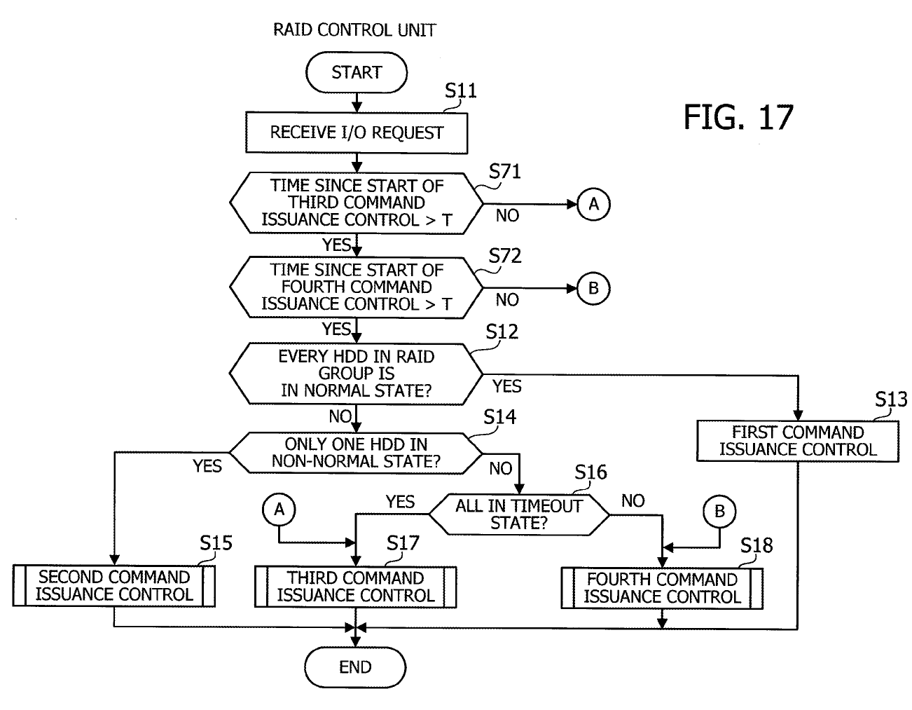

FIG. 17 is a flowchart illustrating a variation of the process of the RAID control unit 220. Some operations in the flowchart of FIG. 17 are similar to those in FIG. 7. FIG. 17 thus uses like step numbers for like steps. Refer to the previous description for details of such steps. It is noted that FIG. 17 is different from FIG. 7 in that steps S71 and 72 are inserted between step S11 and step S12.

(Step S71) The status determination unit 221 in the RAID control unit 220 checks the elapsed time since the start of the third command issuance control of step S17. More specifically, this “elapsed time” refers to the time passed since the command issuance control unit 222 has switched its command issuance control to the third command issuance control from other types. When it is found that the elapse time has reached a specified time T, the process advances to step S72. Otherwise the process executes step S17.

(Step S72) The status determination unit 221 checks the elapsed time since it has started execution of the fourth command issuance control of step S18. The “elapsed time” in this step S72 refers to the time passed since the command issuance control unit 222 has switched its command issuance control to the fourth command issuance control from other types. When it is found that the elapse time has reached a specified time T, the process advances to step S12. Otherwise the process executes step S18.

In operation, the command issuance control unit 222 continues to use the third command issuance control for a while once it chooses that option, however the status of HDDs in the identified RAID group may vary. The command issuance control unit 222 also continues to use the fourth command issuance control for a while once it chooses that option, however the status of HDDs in the identified RAID group may vary. These features ensures persistence of the third and fourth command issuance control, thus making these control schemes more effective in reducing delay of command execution.

As a possible variation, the feature of continuing particular control schemes may also be applied to the second command issuance control in expectation of the effect of reducing load and command delay. The second command issuance control is, however, not necessarily effective when two or more non-NORMAL HDDs exist in a single RAID group, because the benefit of load reduction and the like applies only to one of those non-NORMAL HDDs. It is therefore preferable to confine the use of the second command issuance control as seen in the flowchart of FIG. 17; that is, step S15 is executed only when the process chooses YES at step S14.

It is noted that the third and fourth command issuance control schemes try to suppress the delay of commands more vigorously than the second command issuance control. For this reason, the process illustrated in FIG. 17 is supposed to work well enough to reduce the command delays although it only allows the third and fourth command issuance control schemes to exert their effect for an extended time.

As another possible variation of FIG. 17, the feature of extending the effective duration of particular control may be applied to either the third command issuance control or the fourth command issuance control, but not both. For example, that the noted feature may be configured to work with the fourth command issuance control alone. In this case, the process of FIG. 17 is modified to execute step S72 next to step S11 (i.e., step S71 is removed). This modification is supported by the following grounds. The third command issuance control, when executed, causes an increase of commands, which is not desirable when there is an HDD in HIGH state or HIGH|TIMEOUT state. Extending the effective duration of the fourth command issuance control alone means that the third command issuance control is executed only when the decision at step S16 is YES. The noted modification thus makes it possible to prevent commands from piling up in the command queue of highly-loaded HDDs.

Yet another possible variation of FIG. 17 is to execute step S13 or S18, instead of S17, when the decision at step S71 is NO and only when the RAID group is found to include at least one HDD in HIGH or HIGH|TIMEOUT state. This variation causes the command issuance control unit 222 to stop executing the third command issuance control when an HDD becomes overloaded with pending commands, even if it is before expiration of the extended effective duration of the third command issuance control.

The above sections have discussed data read operation according to the second embodiment. For data write operation, the flowchart of FIG. 7 or 17 may be modified as follows, noting that the second command issuance control does not work for writing data. When a write request is received, the RAID control unit 220 executes a modified version of step S14. That is, the command issuance control unit 222 executes the third command issuance control of step S17 when only one HDD is found to be in TIMEOUT state. The command issuance control unit 222 executes the fourth command issuance control of step S18 when only one HDD is found to be in HIGH or HIGH|TIMEOUT state.

### (c) Third Embodiment

This section describes a third embodiment as a variation of the second embodiment. Specifically, the command issuance control unit 222 is modified to control issuance of commands on an individual HDD basis, rather than on a RAID group basis.

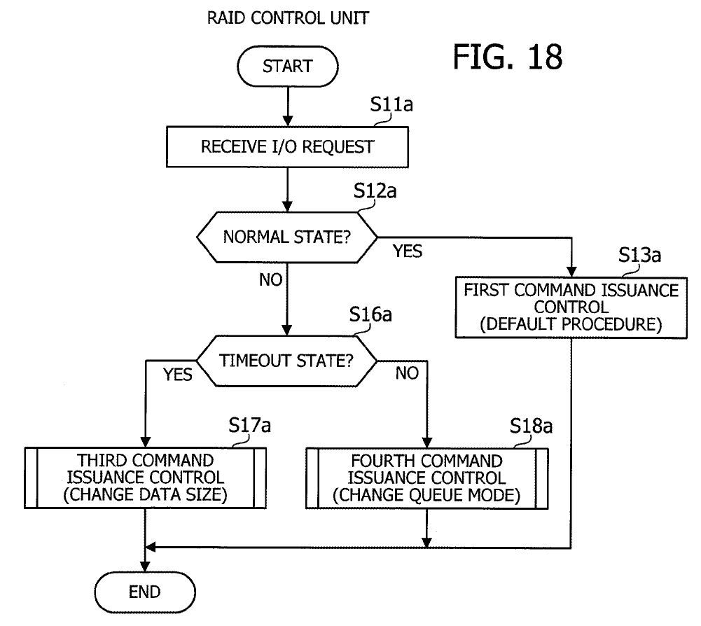

FIG. 18 is a flowchart illustrating exemplary processing performed by the RAID control unit 220 according to the third embodiment.

(Step S11a) The RAID control unit 220 receives a read request from the host I/O control unit 210. The requested data may be stored across a plurality of HDDs. Note that the next step S12a and its subsequent steps are executed for each of those HDDs.

(Step S12a) The status determination unit 221 in the RAID control unit 220 retrieves information on the status of the HDD of interest from the disk management table 250 and determines whether the HDD is in NORMAL state. When the HDD is found to be in NORMAL state, the process branches to step S13a. When it is other than NORMAL, the process advances to step S16a.

(Step S13a) The command issuance control unit 222 in the RAID control unit 220 executes the first command issuance control as its default procedure in normal conditions. This step S13a is basically similar to step S13 of FIG. 7, except that the command issuance control unit 222 supplies the disk control unit 230 with only one ACB.

(Step S16a) The command issuance control unit 222 determines whether the HDD of interest is in TIMEOUT state. When the HDD is found to be in TIMEOUT state, the process advances to step S17a. When it isn't (i.e., when the HDD is in NORMAL, HIGH, or HIGH|TIMEOUT state), the process advances to step S18a.

(Step S17a) The command issuance control unit 222 executes third command issuance control basically in the same way as step S17 of FIG. 7. The difference is that the command issuance control unit 222 produces and provides only one ACB for the disk control unit 230 to issue a command to the HDD.

(Step S18a) The command issuance control unit 222 executes fourth command issuance control basically in the same way as step S18 of FIG. 7. The difference is that the command issuance control unit 222 produces and provides only one ACB for the disk control unit 230 to issue a command to the HDD.

The third embodiment may be modified in the same way as done in FIG. 17 for the second embodiment. That is, the command issuance control unit 222 may continue to use the third command issuance control for a while once it chooses that option, however the status of HDD of interest may vary. The command issuance control unit 222 may also continue to use the fourth command issuance control for a while once it chooses that option, however the status of HDD of interest may vary. It is further possible to configure the command issuance control unit 222 not to execute the third command issuance control when the HDD of interest becomes overloaded with pending commands, even if it is before expiration of the extended effective duration of the third command issuance control.

The third embodiment described above reduces the probability of command timeout while alleviating the slowdown of data read operations on the HDDs. While the above description of FIG. 18 has assumed reception of a data read request, the illustrated procedure may also be able to handle data write requests.

The storage control apparatus and processing functions of CMs described above in various embodiments and their variations may be implemented by using a computer. The processing functions of each device and component are encoded in a computer program and stored in a computer-readable storage medium. A computer system executes this program to provide the intended functions. Such programs may be stored in computer-readable media, which include magnetic storage devices, optical discs, magneto-optical storage media, semiconductor memory devices, and the like. Magnetic storage devices include hard disk drives (HDD), flexible disks (FD), and magnetic tapes, for example. Optical disc media include DVD, DVD-RAM, CD-ROM, CD-RW, and others. Magneto-optical storage media include magneto-optical discs (MO), for example.

Portable storage media, such as DVD and CD-ROM, are used for distribution of program products. Network-based distribution of software programs may also be possible, in which case several master program files are made available in storage devices of a server computer for downloading to other computers via a network.

For example, a computer stores various software components in its local storage device, which have previously been installed from a portable storage medium or downloaded from a server computer. The computer executes programs read out of the local storage device, thereby performing the programmed functions. Where appropriate, the computer may execute program codes read out of a portable storage medium, without installing them in its local storage device. Another alternative method is that the user computer dynamically downloads programs from a server computer when they are demanded and executes them upon delivery.

Various embodiments of the proposed storage system, storage control method, and storage control program have been discussed above. According to an aspect of those embodiments, the execution of commands becomes less prone to delay in storage devices.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage system comprising:
a storage device; and
a control apparatus that sets an upper limit to write data size or read data size specified in commands for reading data from or writing data to the storage device, and sends the storage device a command whose write data size or read data size is restricted by the upper limit.

2. The storage system according to claim 1, wherein the control apparatus applies the upper limit to the write data size or read data size during a predetermined period after detection of a timeout of a command sent to the storage device.

3. The storage system according to claim 2, wherein the control apparatus determines whether or not to apply the upper limit to the write data size or read data size, based on a number of pending commands in the storage device.

4. The storage system according to claim 3, wherein the control apparatus specifies a first mode for commands to be sent to the storage device when the number of pending commands is greater than or equal to a threshold, the first mode causing the storage device to execute the pending commands in order of receipt.

5. The storage system according to claim 4, wherein:
the control apparatus further determines whether the commands to be sent to the storage device are sequential access commands or random access commands, when the number of pending commands is found to be greater than or equal to the threshold;
when the commands are found to be random access commands, the control apparatus specifies the first mode to cause the storage device to execute the commands in order of receipt; and
when the commands are found to be sequential access commands, the control apparatus specifies a second mode for the commands, the second mode allowing the storage device to change execution order of the commands.

6. The storage system according to claim 4, wherein the control apparatus continues to specify the first mode in sending further commands during a period with a predetermined length, once the control apparatus has specified the first mode in sending one command to the storage device.

7. The storage system according to claim 1, wherein the control apparatus continues to apply the upper limit to the write data size or the read data size during a period with a predetermined length, once the control apparatus has applied the upper limit in sending one command to the storage device.

8. The storage system according to claim 1, wherein:
the storage device is provided in plurality;
the control apparatus controls access to the storage devices, including a write data operation to be performed such that segments of write data and an additional piece of data calculated for redundancy are distributed across the plurality of storage devices; and
the control apparatus applies the upper limit to the write data size or read data size of commands to be transmitted to one of the storage devices that has been in timeout state, the timeout state being a state of a storage device that lasts for a predetermined time after detection of a timeout of execution of a received command.

9. The storage system according to claim 8, wherein:
the control apparatus determines whether each of the storage devices is in high-load state, based on a number of pending commands accumulated therein; and
when at least one of the storage devices is found to be in high-load state, the control apparatus determines not to apply the upper limit to the write data size or read data size of commands to be transmitted to the storage device found to be in high-load state.

10. The storage system according to claim 9, wherein:
the control apparatus produces parity for redundancy in writing data across different storage devices;
when a number of storage devices in timeout state or high-load state is smaller than or equal to a number of parities per stripe, the control apparatus reads a stripe of data out of the storage devices by using the parity read out of other storage devices to reconstruct data supposed to be stored in the storage devices in timeout state or high-load state, instead of reading the data out of the storage devices in timeout state or high-load state, as well as determining not to apply the upper limit to the read data size of the read commands.

11. The storage system according to claim 10, wherein:
when the number of storage devices in timeout state or high-load state is greater than the number of parities per stripe, the control apparatus determines whether any of the storage devices is in high-load state;
when none of the storage devices is found to be in high-load state, the control apparatus applies the upper limit to the write data size or read data size of commands to be transmitted to the storage devices; and
when one of the storage devices is found to be in high-load state, the control apparatus determines not to apply the upper limit to the write data size or read data size of commands to be transmitted to the storage devices.

12. The storage system according to claim 11, wherein:
the control apparatus determines whether commands to be transmitted to one of the storage devices are sequential access commands or random access commands, when the number of storage devices in timeout state or high-load state is greater than the number of parities per stripe, and when one of the storage devices is found to be in high-load state;
when the commands are found to be random access commands, the control apparatus specifies a first mode for the commands to cause the one of the storage devices to execute the commands in order of receipt; and
when the commands are found to be sequential access commands, the control apparatus specifies a second mode for the commands to allow the one of the storage devices to change execution order of the commands.

13. A storage control method for use by a control apparatus that controls access to a storage device, the method comprising:
setting an upper limit to write data size or read data size specified in commands for reading data from or writing data to the storage device; and
sending the storage device a command whose write data size or read data size is restricted by the upper limit.

14. The storage control method according to claim 13, further comprising applying the upper limit to the write data size or read data size during a predetermined period after a timeout of a command sent to the storage device.

15. The storage control method according to claim 14, further comprising determining whether or not to apply the upper limit to the write data size or read data size, based on a number of pending commands in the storage device.

16. The storage control method according to claim 15, further comprising specifying a first mode for commands to be sent to the storage device when the number of pending commands is greater than or equal to a threshold, the first mode causing the storage device to execute the pending commands in order of receipt.

17. The storage control method according to claim 16, further comprising:
determining whether the commands to be sent to the storage device are sequential access commands or random access commands, when the number of pending commands is found to be greater than or equal to the threshold;
specifying the first mode to cause the storage device to execute the commands in order of receipt, when the commands are found to be random access commands; and
specifying a second mode for the commands to allow the storage device to change execution order of the commands, when the commands are found to be sequential access commands.

18. The storage control method according to claim 13, wherein:
the control apparatus is coupled to a plurality of storage devices;
the storage control method further comprises:
controlling access to the storage devices, including a write data operation to be performed such that segments of write data and an additional piece of data calculated for redundancy are distributed across the plurality of storage devices; and
applying the upper limit to the write data size or read data size of commands to be transmitted to one of the storage devices that has been in timeout state, the timeout state being a state of a storage device that lasts for a predetermined time after detection of a timeout of execution of a received command.

19. The storage control method according to claim 18, further comprising:
determining whether each of the storage devices is in high-load state, based on a number of pending commands accumulated therein; and
determining not to apply the upper limit to the write data size or read data size of commands to be transmitted to the storage device found to be in high-load state, when at least one of the storage devices is found to be in high-load state.

20. A computer-readable storage medium storing a program for controlling access to a storage device, the program causing a computer to perform a procedure comprising:
setting an upper limit to write data size or read data size specified in commands for reading data from or writing data to the storage device; and
sending the storage device a command whose write data size or read data size is restricted by the upper limit.
